(19) United States
(12) Patent Application Publication
(10) Pub. No.: US 2025/0187206 A1
(43) Pub. Date: Jun. 12, 2025

(54) TOOL SWITCHING APPARATUS

(71) Applicant: ABB SCHWEIZ AG, Baden (CH)

(72) Inventors: Chongyuan Qian, Shanghai (CN); Yang Li, Shanghai (CN); Hao Wang, Shenzhen (CN); Yin Tian, Shanghai (CN)

(21) Appl. No.: 19/058,983

(22) Filed: Feb. 20, 2025

Related U.S. Application Data
(63) Continuation of application No. PCT/CN2022/117846, filed on Sep. 8, 2022.

(51) Int. Cl. B25J 15/04

(52) U.S. Cl. CPC B25J 15/0425; B25J 15/0416

(57) ABSTRACT

A tool switching apparatus includes a main body with an opening, the opening being configured to receive a tool and defining a centerline. A plurality of clamping jaws is provided around the opening, each clamping jaw being configured to rotate around a respective pivot fixedly coupled to the main body. The clamping jaw includes a first protrusion, a second protrusion, and a flat spring fixedly coupled to the main body. The clamping jaw is configured to rotate around the pivot in a first rotational direction under an actuation exerted by the tool to allow the first protrusion to move away from the centerline of the opening.

### FIELD

Example embodiments of the present disclosure generally relate to the field of machining industry, and more particularly, to a quick-change tool switching apparatus used in machining of industrial robots.

### BACKGROUND

Most of the machining processes in the machining industrials need to be completed by removing materials. Milling, turning, boring, drilling and grinding all need to be completed by the contact between the tool and the workpiece to be machined, and such a contact will bring about the problems of tool fixing, loss and replacement. With the use of the tool, the tool will be worn out and it is necessary to replace the used tool. Currently, there are many kinds of tool fixing and replacing methods on the market. However, most of these approaches are operated manually, which affects the cycle time.

### SUMMARY

In general, example embodiments of the present disclosure provide a tool switching apparatus.

In an aspect, there is provided a tool switching apparatus. The tool switching apparatus comprises: a main body comprising an opening, the opening being configured to receive a tool and defining a centerline; a plurality of clamping jaws provided around the opening, each clamping jaw being configured to rotate around a respective pivot fixedly coupled to the main body and comprising: a first protrusion provided adjacent to the opening and extending towards the opening; and a second protrusion provided at a side opposite to the first protrusion about the pivot; and a flap spring fixedly coupled to the main body at one end and coupled to the second protrusion at the other end, the clamping jaw is configured to rotate around the pivot in a first rotational direction under an actuation exerted by the tool to allow the first protrusion to move away from the centerline of the opening, so as to receive the tool and bias the flap spring.

According to example embodiments, the loading and unloading of the tool can be carried out automatically and conveniently by the robot without use of any external power source.

In some example embodiments, the clamping jaw is further configured to rotate around the pivot in a second rotational direction opposite to the first rotational direction under the force of the flat spring to allow the first protrusion to move towards the centerline of the opening to clamp the tool.

In some example embodiments, the tool switching apparatus further comprises a collar provided outward from the clamping jaws and configured to be stopped by a unloading base; when the clamping jaw moves parallel to the centerline, the second protrusion is actuated by the collar to cause the clamping jaw to rotate around the respective pivot in the first rotational direction, so as to allow the first protrusion to move away from the centerline of the opening to release the tool.

In some example embodiments, the tool switching apparatus further comprises a pushing component provided within a first slot above the opening and configured to push the tool and drive the tool to fall from the tool switching apparatus into the unloading base.

In some example embodiments, the clamping jaw comprises a third protrusion extending away from the centerline of the opening, the third protrusion comprises a protrusion surface inclined with respect to the centerline of the opening by an angle less than a predetermined threshold.

In some example embodiments, the tool switching apparatus further comprises: a slot provided within the main body and extending in a direction non parallel to the centerline of the opening; and a ball plunger provided within the slot, a ball of the ball plunger being configured to be compressed by an outer surface of the tool and popped up into a groove of the tool when the ball detaches from the outer surface.

In some example embodiments, the third protrusion is perpendicular to the centerline of the opening.

In some example embodiments, the plurality of clamping jaws are equidistantly distributed around the opening.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a perspective view of a tool switching apparatus along with two bases in accordance with an example embodiment of the present disclosure;

FIG. 2 illustrates an example sectional view of the tool switching apparatus and

the bases as shown in FIG. 1;

FIG. 3 illustrates a perspective view of a tool switching apparatus in accordance with an example embodiment of the present disclosure;

FIG. 4 illustrates an example sectional view of the tool switching apparatus as shown in FIG. 3;

FIG. 5 illustrates a perspective view of the clamping jaw in accordance with an example embodiment of the present disclosure;

FIGS. 6A-6D illustrate example steps of loading the tool onto the tool switching apparatus in accordance with an example embodiment of the present disclosure;

FIGS. 7A-7D illustrate example steps of unloading the tool from the tool switching apparatus in accordance with an example embodiment of the present disclosure; and

FIG. 8 illustrates an enlarged view of the clamping jaw in accordance with an example embodiment of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, there are many kinds of tool fixing and replacing methods on the market. Among these conventional approaches, some of them require manual replacement of the tool head, which cannot be perfectly applied in automatic equipment. Some of them should be pre-installed into the tool handle and must be matched with a tool handle, which has high cost, large overall dimensions, and cannot be used in space limited or small-scale processing occasions.

At least to address the problem existed in the conventional approaches, the present disclosure proposes a solution realizing the rapid replacement of tool without external power sources. Moreover, the tool switching apparatus can be adapted to various brand and model of the tool and can be used by modifying the fitting installation structure, which allows the end customer to realize the functions of batch loading, automatic replacement, automatic unloading of equipment consumable tools.

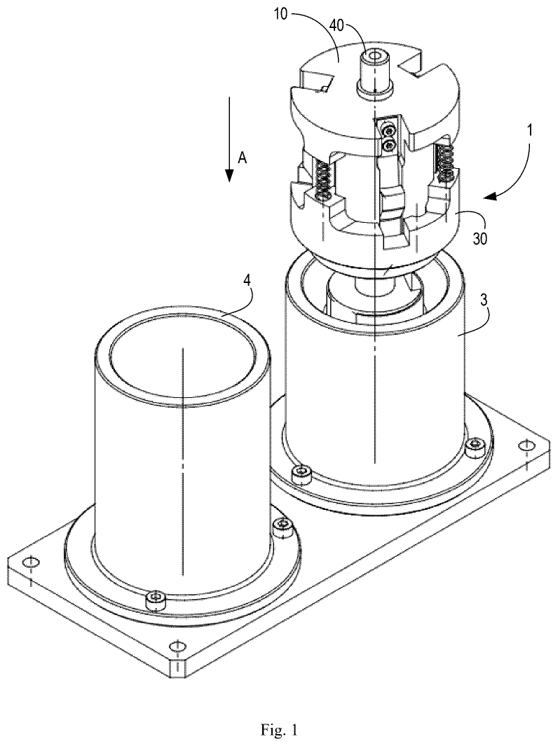

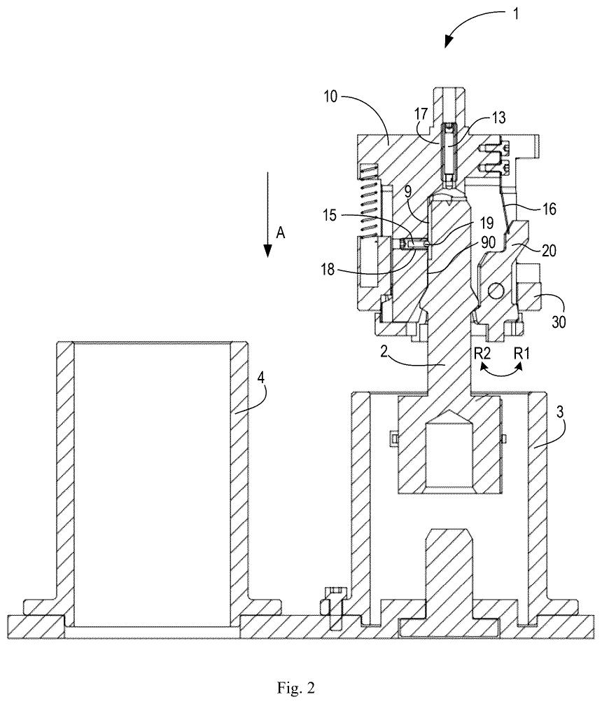

Example embodiments will be described in more detail hereinafter in accordance with FIGS. 1-8. With reference to FIGS. 1-2 at first, wherein FIG. 1 illustrates a perspective view of a tool switching apparatus 1 along with two bases in accordance with an example embodiment of the present disclosure, and FIG. 2 illustrates an example sectional view of the tool switching apparatus 1 and the bases as shown in FIG. 1.

As illustrated in FIG. 1, two bases are shown, e.g., a loading base 3 and a unloading base 4. The loading base 3 is used to contain a new tool 2 to be mounted on the tool switching apparatus 1 while the unloading base 4 is used to receive the tool 2 after being used and replaced. The tool switching apparatus 1 may be mounted to a robot (not shown) and handled by the robot. For example, as shown in FIG. 1, a shaft 40 may extend from a main body 10 of the tool switching apparatus 1 and may be grasped by the robot. With the control of the robot the tool switching apparatus 1 may be actuated to any desired position. For example, the tool switching apparatus 1 may be grasped by the robot via the shaft 40 to move inside the loading base 3 to allow the new tool 2 within the loading base 3 to be mounted onto the tool switching apparatus 1. In some example embodiments, the tool 2 may be a grinding head. It is to be understood that, other types of tools 2 are possible as well. The tool 2 mounted to the tool switching apparatus 1 may be used to carry out the predetermined task. For example, if the tool 2 is a grinding head, it can be used to polish a workpiece. After completing the predetermined task, the tool 2 should be replaced according to its degree of wear. In this situation, the tool switching apparatus 1 may also be grasped by the robot to move adjacent to the unloading base 4 to discharge the used tool 2.

According to the present disclosure, the tool 2 can be loaded and unloaded conveniently and it is no need to rely on external power source to change the tool 2.

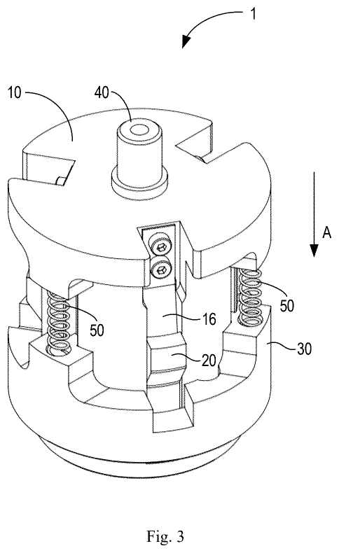

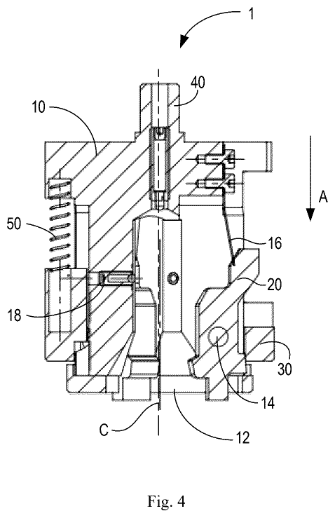

The details of the tool switching apparatus 1 will be described in more details hereinafter with reference to FIGS. 3-6, wherein FIG. 3 illustrates a perspective view of a tool switching apparatus 1 in accordance with an example embodiment of the present disclosure; and FIG. 4 illustrates an example sectional view of the tool switching apparatus 1 as shown in FIG. 3.

As shown in FIGS. 3 and 4, the tool switching apparatus 1 generally comprises a main body 10 and a plurality of clamping jaws 20. The main body 10 includes an opening 12 in its middle, and the opening 12 is configured to receive the tool 2. In the shown embodiments, three clamping jaws 20 are included and are provided around the opening 12. It is to be understood that the number of the clamping jaws 20 are merely example without suggesting any limitation as to the scope of the present disclosure. According to the various scenarios, the tool switching apparatus 1 may include two, four, five, or more clamping jaws 20. In further example embodiments, the clamping jaws 20 may be equidistantly distributed around the opening 12.

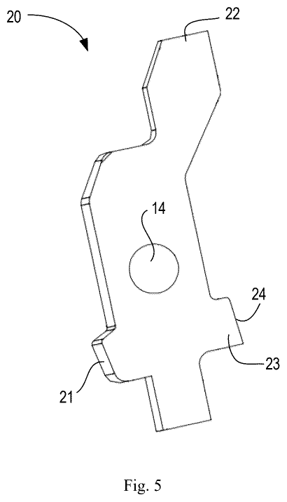

FIG. 5 illustrates a perspective view of the clamping jaw 20 in accordance with an example embodiment of the present disclosure. As shown in FIG. 5, the clamping jaw 20 is configured to rotate around a respective pivot 14, which is fixedly coupled to the main body 10 of the tool switching apparatus 1. The clamping jaw 20 includes a first protrusion 21 and a second protrusion 22. The first protrusion 21 is provided adjacent to the opening 12 and extends towards the opening 12; and the second protrusion 22 is provided at a side opposite to the first protrusion 21 about the pivot 14.

Referring back to FIGS. 3 and 4, the tool switching apparatus 1 also includes a flat spring 16, with one end fixedly coupled to the main body 10 and the other end coupled to the second protrusion 22 of the clamping jaw 20.

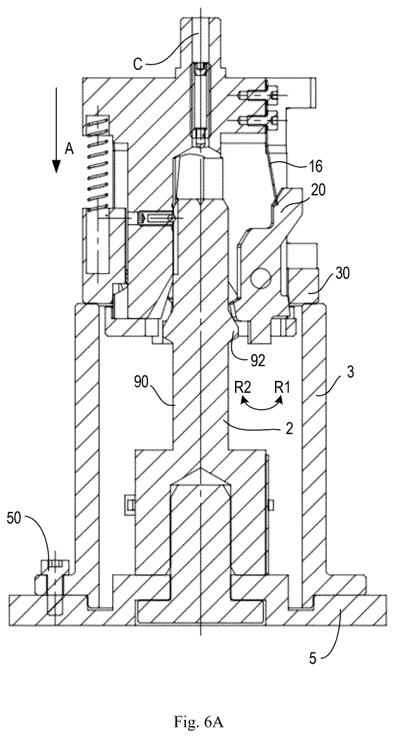

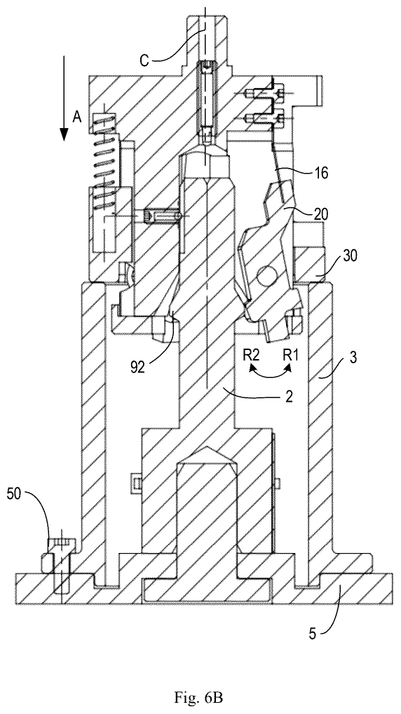

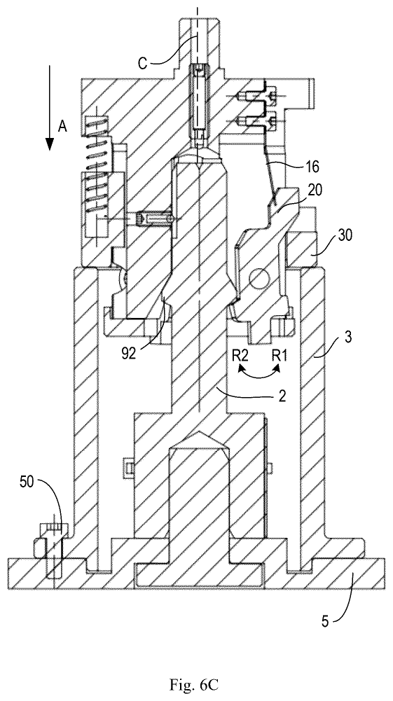

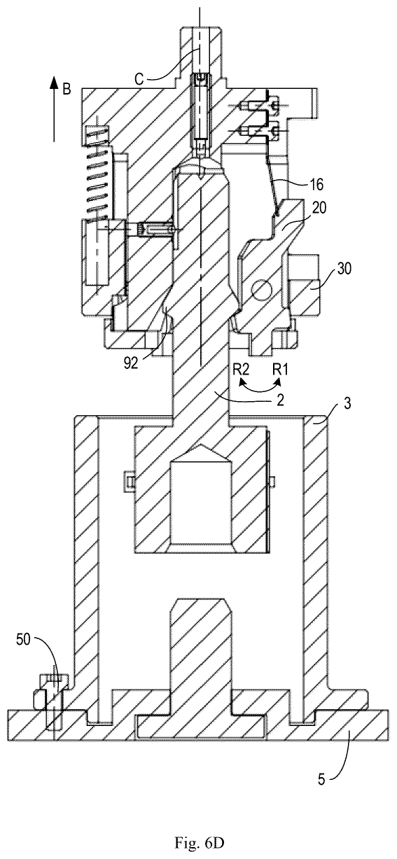

FIGS. 6A-6D illustrate example steps of loading the tool 2 onto the tool switching apparatus 1 in accordance with an example embodiment of the present disclosure.

As shown in FIG. 6A, the loading base 3 is secured to a platform 5 with screws 50. A new tool 2 is provided within the space formed by the loading base 3. In the illustrated embodiments, the loading base 3 may be in a cylindrical form. The tool 2 may include a shaft 90 extending vertically. As illustrated in FIG. 6A, the shaft 90 may include a circular protrusion 92. The tool switching apparatus 1 may be grasped by the robot to move downward along the axial direction A. While the clamping jaw 20 within the tool switching apparatus 1 is moved downward, the first protrusion 21 of the clamping jaw 20 begins to contact the circular protrusion 92 of the tool 2. Since the tool 2 is mounted on the loading base 3, the tool 2 cannot be moved along the axial direction A anymore, which causes the first protrusion 21 to be compressed by a first slope of the circular protrusion 92 to allow the clamping jaw 20 to rotate around the pivot 14 in a first rotational direction R1. As a result, as shown in FIG. 6B, the first protrusion 21 moves away from the centerline C of the opening 12, the opening 12 becomes larger to receive the tool 2 accordingly. Also, during the rotation of the clamping 20 around the pivot 14 along the first rotational direction R1, with reference back to FIG. 4, the second protrusion 22 will bias the flat spring 16.

Referring to FIG. 6C, as the tool switching apparatus 1 continues to move downward along the axial direction A, the first protrusion 21 will move and start to contact a second slope of the circular protrusion 92. As a result, the compressing force of the flat spring 16 will cause the flat spring 16 to reset to rotate the clamping jaw around the pivot 14 in a second rotational direction R2 opposite to the first rotational direction R1. This allows the first protrusion 21 to move towards the centerline C of the opening 12 to clamp the tool 2. In this way, the tool 2 is loaded onto the tool switching apparatus 1.

Referring to FIG. 6D, after the tool 2 has been successfully loaded onto the tool switching apparatus 1; the robot starts to move the tool switching apparatus 1 upwardly in an axial direction B. Consequently, the tool 2 can be detached from the loading base 3 and firmly clamped by the tool switching apparatus 1.

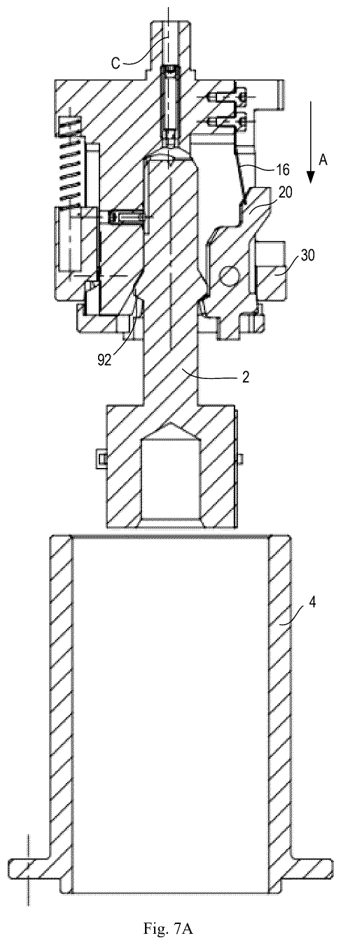

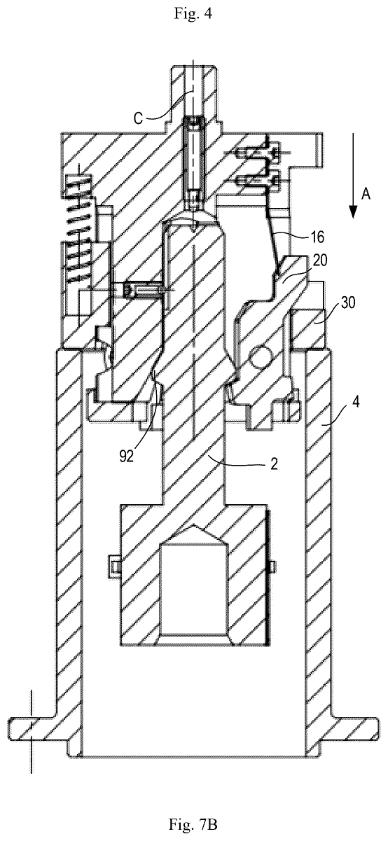

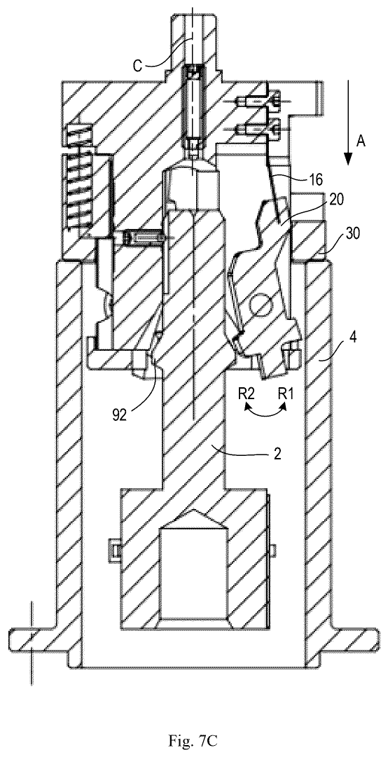

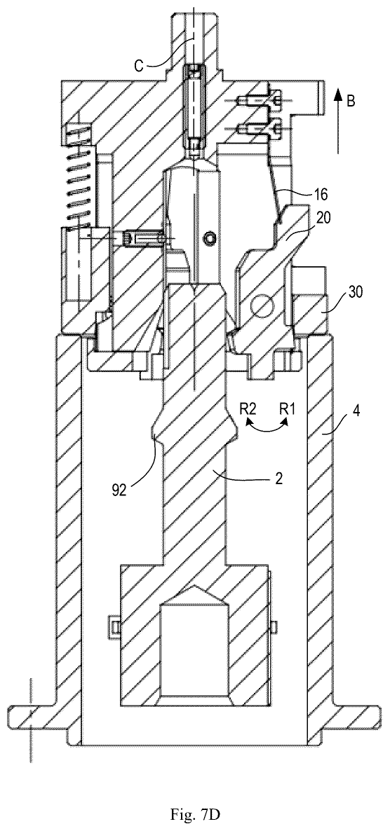

FIGS. 7A-7D illustrate example steps of unloading the tool 2 from the tool switching apparatus 1 in accordance with an example embodiment of the present disclosure.

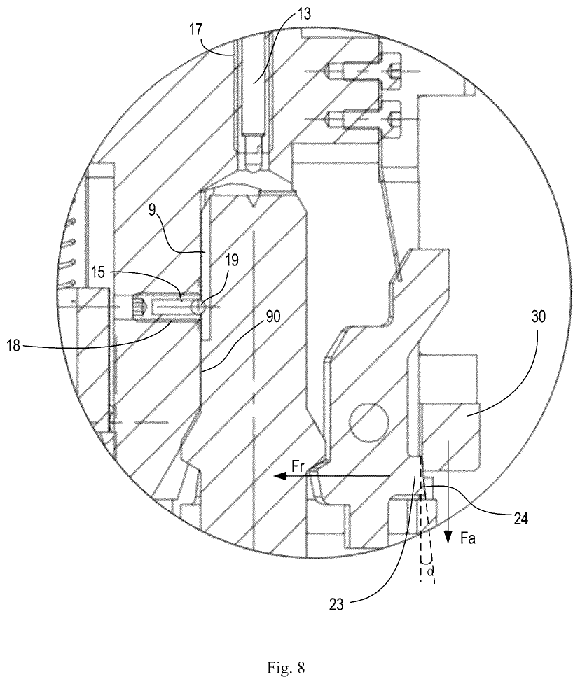

As illustrated in FIG. 7A, the unloading base 4 is provided to receive the used tool 2 to be replaced. Now it is empty. When the tool switching apparatus 1 moves downwardly along the axial direction A, the tool switching apparatus 1 and the tool 2 clamped by the tool switching apparatus 1 approach the unloading base 4. As illustrated in FIG. 8A, the tool switching apparatus 1 may further comprise a collar 30, which is provided outward from the clamping jaws 20.

With reference to FIG. 7B, when the collar 30 begins to contact the unloading base 4, it will be stopped by the unloading base 4, since the unloading base 4 is secured on the platform 5. Even though the collar 30 cannot be moved downward anymore, the clamping jaw 20 and the tool 2 clamped by the clamping jaw 20 can still move downward along the axial direction A until the second protrusion 22 of the clamping jaw 20 starts to touch the collar 30.

With continuous reference to FIG. 7C, the interaction between the second protrusion 22 of the clamping jaw 20 and the collar 30 will drive the clamping jaw 20 to rotate around the pivot 14 in the first rotational direction R1, so as to allow the first protrusion 21 to move away from the centerline C of the opening 12. As a result, the clamping jaw 20 may climb the circular protrusion 92, which causes the opening 12 to become larger to unload the tool 2 from the tool switching apparatus 1.

With reference to FIG. 7D, as the tool switching apparatus 1 continues to move downward along the axial direction A, the clamping jaw 20 can move across the circular protrusion 92. The tool 2 may fall down to the unloading base 4 by gravity.

In some example embodiment, as shown in FIGS. 7C, the tool switching apparatus 1 may include a pushing component 13. The pushing component 13 may be positioned within a first slot 17 provided above the opening 12. The pushing component 13 may be used to push the tool 2 and drive the tool 2 to fall from the tool switching apparatus 1 into the unloading base 4. In this manner, it can be ensured that the tool 2 will be successfully unloaded from the tool switching apparatus 1. The pushing component 13 may be embodied as a ball plunger. In this manner, in addition to the gravity, the tool 2 may fall down to the unloading base 4 also with the help of the ball plunger.

After the tool 2 is detached from the tool switching apparatus 1, the robot may drive the tool switching apparatus 1 to move upwardly in an axial direction B. The opening 12 is now empty and the tool switching apparatus 1 can be loaded with another new tool 2.

According to the example embodiments of the present disclosure, the loading and unloading of the tool 2 can be carried out by the robot without use of any external power source.

When the tool 2 is used for operation, since it is usually needs to rotate at a very high speed, the tool 2 requires to be firmly clamped by the tool switching apparatus 1, otherwise the tool 2 may be disengaged from the tool switching apparatus 1 at a very high rotational speed, which may cause serious injury to the equipment and the personnel. In order to address such a potential risk, a locking mechanism is proposed and will be described with reference to FIG. 8, which illustrates an enlarged view of the clamping jaw 20 in accordance with an example embodiment of the present disclosure.

In the illustrated embodiments, the clamping jaw 20 may comprise a third protrusion 23, which extends away from the centerline C of the opening 12. As shown, the third protrusion 23 may comprise a protrusion surface 24, which inclined with respect to the centerline C of the opening 12 by an angle α. The angle α may be set to be very small, for example, less than a predetermined threshold. In some example embodiments, the angle α may be 5 degrees. It is to be understood that this is only for illustration without suggesting any limitations as to the scope of the subject matter described here and other degrees are also possible for angle α. When the tool 2 is used for operation, the collar 30 will subject to an axial force Fa exerted by the spring 52 of the tool switching apparatus 1. In the illustrated embodiments, since the angle α is small, the axial force Fa will be converted into a relatively large radial force Fr. Therefore, the tool 2 can be firmly clamped by the clamping jaw 20 during the operation of the tool 2.

In some example embodiment, as shown in FIGS. 2 and 8, the tool switching apparatus 1 may further comprise a second slot 18 within the main body 10 and extending in a direction non parallel to the centerline C of the opening 12. In further example embodiments, the third protrusion 23 may be perpendicular to the centerline C of the opening 12. A ball plunger 15 may be provided within the second slot 18. The ball plunger 15 may include a ball 19, which may be compressed by the outer surface of the tool 2. The tool 2 may include a groove 3, the groove 3 may allow the ball 19 to be popped up under a resilient force. In this way, the ball 19 may be accurately located into the groove 3 of the tool 2. Therefore, the relative circumferential position between the tool 2 and the tool switching apparatus 1 may be determined. With these embodiments, the tool 2 can be firmly secured relative to the tool switching apparatus 1 to ensure the safety when the tool 2 is rotating a the high rotational speed for the desired task.

Compared with the conventional approaches, the tool switching apparatus 1 may be adapted to different processing tools according to different use scenarios and is small in size and light in weight. Moreover, the loading and unloading of the tool 2 may be carried out by robots without external power.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A tool switching apparatus, comprising:
a main body comprising an opening, the opening being configured to receive a tool and defining a centerline;
a plurality of clamping jaws provided around the opening, each clamping jaw being configured to rotate around a respective pivot fixedly coupled to the main body and comprising:
a first protrusion provided adjacent to the opening and extending towards the opening; and
a second protrusion provided at a side opposite to the first protrusion about the pivot; and
a flat spring fixedly coupled to the main body at one end and coupled to the second protrusion at another end,
the clamping jaw is configured to rotate around the pivot in a first rotational direction under an actuation exerted by the tool to allow the first protrusion to move away from the centerline of the opening, so as to receive the tool and bias the flat spring.

2. The tool switching apparatus of claim 1, wherein the clamping jaw is further configured to rotate around the pivot in a second rotational direction opposite to the first rotational direction under a force of the flat spring to allow the first protrusion to move towards the centerline of the opening to clamp the tool.

3. The tool switching apparatus of claim 1, further comprising:
a collar provided outward from the clamping jaws and configured to be stopped by a unloading base;
wherein when the clamping jaw moves parallel to the centerline, the second protrusion is actuated by the collar to cause the clamping jaw to rotate around the respective pivot in the first rotational direction, so as to allow the first protrusion to move away from the centerline of the opening to release the tool.

4. The tool switching apparatus of claim 3, further comprising:
a pushing component provided within a first slot above the opening and configured to push the tool and drive the tool to fall from the tool switching apparatus into the unloading base.

5. The tool switching apparatus of claim 3, wherein the clamping jaw comprises a third protrusion extending away from the centerline of the opening, the third protrusion comprises a protrusion surface inclined with respect to the centerline of the opening by an angle less than a predetermined threshold.

6. The tool switching apparatus of claim 1, further comprising:
a slot provided within the main body and extending in a direction non-parallel to the centerline of the opening; and
a ball plunger provided within the slot, a ball of the ball plunger being configured to be compressed by an outer surface of the tool and popped up into a groove of the tool when the ball detaches from the outer surface.

7. The tool switching apparatus of claim 5, wherein the third protrusion is perpendicular to the centerline of the opening.

8. The tool switching apparatus of claim 1, wherein the plurality of clamping jaws are equidistantly distributed around the opening.
